(19) United States
(12) Patent Application Publication
(10) Pub. No.: US 2008/0228397 A1
(43) Pub. Date: Sep. 18, 2008

(54) REVERSE MAP DETERMINATION OF LOCATIONS AND ADDRESSES

(75) Inventors: Michael J. Crowley, Oak Park, IL (US); Gary L. DeGregorio, Sleepy Hollow, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/686,534

(22) Filed: Mar. 15, 2007

(51) Int. Cl. G01C 21/00

(52) U.S. Cl. 701/213; 701/300

(57) ABSTRACT

A method and a system for determining a reverse map of locations and addresses are disclosed. The method includes receiving information from a user about a segment of a route (204), determining the segment and a new via point using a map database (206), determining whether the new via point is a final via point (208), and determining the address of the destination after the new via point has been determined to be the final via point (218). The method also includes repeating the receiving of the information and the determining of the segment when the new via point is not the final via point.

### FIELD OF THE INVENTION

The present invention relates generally to route location determination, and more particularly to determining an address of a route destination

### BACKGROUND

Navigation systems are well known for guiding a user. Typically, present navigation systems generate a route between a source and a destination when the addresses for the same are fed into the system. For example, MapQuest determines a route between two locations when addresses for both the locations are provided to the system. Present navigation systems may generate shortest distance or fastest route, but there exists no navigation system that can determine address of a destination from a description of a route to the destination.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a route as described by a user in accordance with some embodiments;

FIG. 2 is a flowchart of some steps of a method in accordance with some embodiments;

FIG. 3 is a block diagram of an electronic device is shown in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in user electronic device that function in a system. Accordingly, the apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

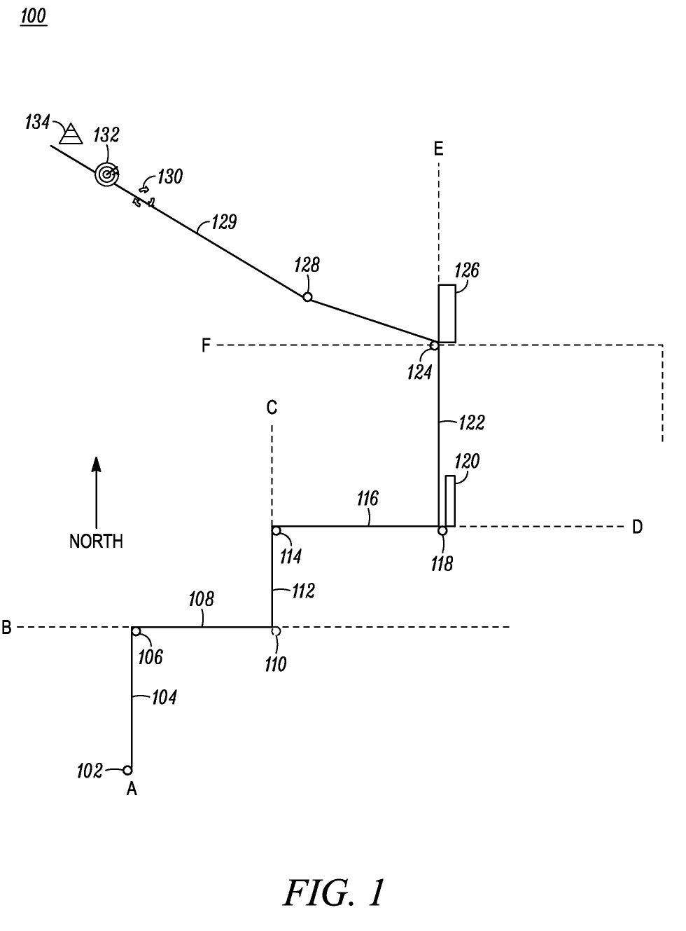

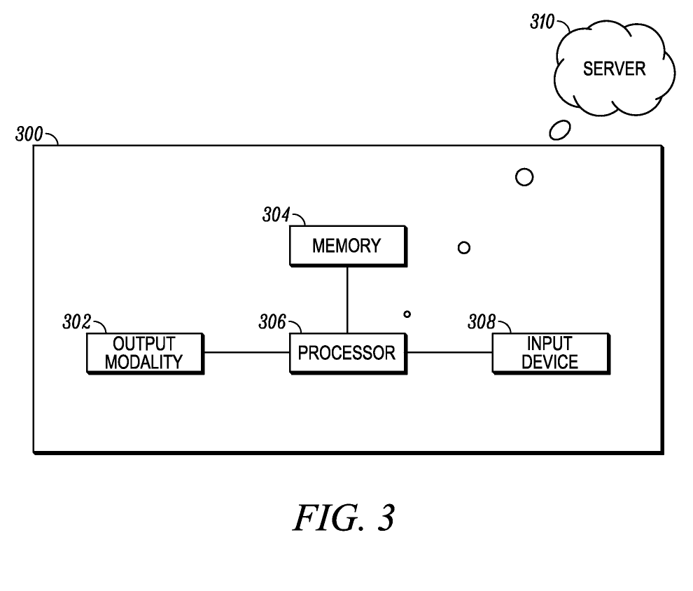

FIG. 1 illustrates a route 100 as described by a user in accordance with some embodiments. The route 100 may comprise a plurality of connected segments, a plurality of via points (106, 110, 114, 118, 124, 128), a plurality of structures (120, 126), an approximate location 132, a candidate address 130 and a destination 134. The route 100 ends at the destination 134. The user may be keen to know some information about the destination 134. For example, the information could be the address of the destination 134 or it could be the name of the resident at the destination 134 or it could be the name of the building/business, etc. The user needs to explain the route 100 to an electronic device 300 (as shown in FIG. 3) to learn all or any of the above information. The user may describe the route 100 to the electronic device 300 using any user modality available in the electronic device 300, such as speech, text or strokes. When the user provides information in the form of strokes, the user actually draws the route 100 on a touch sensitive device. The touch sensitive device can be a touch screen or a touch pad. For example, the user providing information in the form of strokes is equivalent to a scenario where the user explains the route 100 to a person by literally drawing the route 100 on a sheet of paper. In addition, the user may also draw the route 100 over a map being displayed by the electronic device 300. Moreover, a Global Positioning System (GPS) device could also be used to provide information to the electronic device 300 to generate the route 100.

FIG. 1 is an example of a manner in which the route 100 may be explained. The user may provide a starting location 102 to the electronic device 300. The starting location 102 is the point from where the electronic device 300 starts determining the route 100 to the destination 134. The starting location 102 is at the beginning of road A (as shown in FIG. 1). The user may speak out the directions to the electronic device 300 so that the electronic device 300 may generate the route 100 to the destination 134. The user may say “start from road A towards north and take a right from the intersection of road A and road B”. The route 100 generated along one road or path using direction may be referred to as a first segment 104 and the intersection of the roads A and B may be referred to as a first via point 106. After the first segment 104 and the first via point 106 are determined, the electronic device 300 may ask the user for the verification of the first via point 106 and the first segment 104. When the first segment 104 and the first via point 106 are verified, the electronic device 300 stores the information about both the first via point 106 and the first segment 104 into a memory 304 (which could be external or internal). If the first segment 104 and the first via point 106 as determined by the electronic device 300 do not come out to be the segment and the via point as explained by the user, then the electronic device 300 may discard the information. Then, the electronic device 300 may ask the user to provide the information again, in some instances in a different manner. The user may then provide the information in a different manner and when the route 100 generated by the electronic device 300 is verified by the user then the electronic device 300 may ask the user for next set of commands.

For the illustrated route 100, after the first via point 106 and the first segment 104 are determined, the user may say “turn right from the first intersection and move on road B until road B intersects with road C and then take a left from the intersection of road B and road C”. The route 100 on road B may be referred to as a second segment 108 and the intersection of road B and road C may be referred to as a second via point 110. The user may also provide information regarding the distance to be traveled in a certain direction. After the second segment 108 and the second via point 110 are determined, the electronic device 300 may ask the user for the verification of the second via point 110 and the second segment 108. When the second segment 110 and the second via point 110 are verified, the electronic device 300 stores the information about both the second via point 110 and the second segment 108 into the memory 304. If the second segment 108 and the second via point 110 as determined by the electronic device 300 do not come out to be the segment and via point as explained by the user, then the electronic device 300 may discard the information. Then, the electronic device 300 asks the user to provide the information again, in some instances in a different manner. The user then provides the information again and when the route 100 generated by the electronic device 300 is verified by the user then the electronic device 300 may ask the user for next set of commands.

After the second segment 108 and the second via point 110 are determined, a similar method is followed to determine more segments (such as segments 112, 116, 122, 129) and via points (such as via points 114, 118, 124, 128) until the route 100 to an approximate location 132 near the destination 134 is described. Furthermore, in addition to the intersections, via points may be identified using landmarks or structures (120, 126) to determine the approximate location 132 of the destination 134. For example, when the user says “turn left from the structure 120”, then the structure 120 may be referred to as fourth via point 118. The user may also point out a landmark and refer the landmark as via point to give further directions to the electronic device 300. For example, the user may say “go to the water tower and take the first right turn” (not shown in FIG. 1) and the water tower may be referred to as another via point. The structures and the landmarks could be shown on the map. In addition, the user may also use a distance to be traveled in a particular direction as a next segment. For example, the user may say “go three miles in a particular direction and then take the first right turn”. So the three mile distance may be referred to as the next segment. Moreover, the user may further traverse several segments on the map and then use a GPS device to identify further via points. The cycle of determining, verifying and storing the segments and via points into the memory 304 will continue until the route 100 to the destination 134 is determined by the electronic device 300. The approximate location 132 is a location that is very close to the destination 134.

The electronic device 300 may also generate a specific via list without creating fake stopping points. The specific via list may exclude fake stopping points. The fake stopping points may include points where the user may stop for not so good reasons like stopping at a petrol station for fuel, etc., which may be indicated as such by the user.

After the approximate location 132 is determined, a candidate address 130 is also determined by the electronic device 300. The candidate address 130 is an address that is typically one that is nearest to the approximate location 132. The approximate location 132 and the candidate address 130 are the key factors to determine the address of the destination 134.

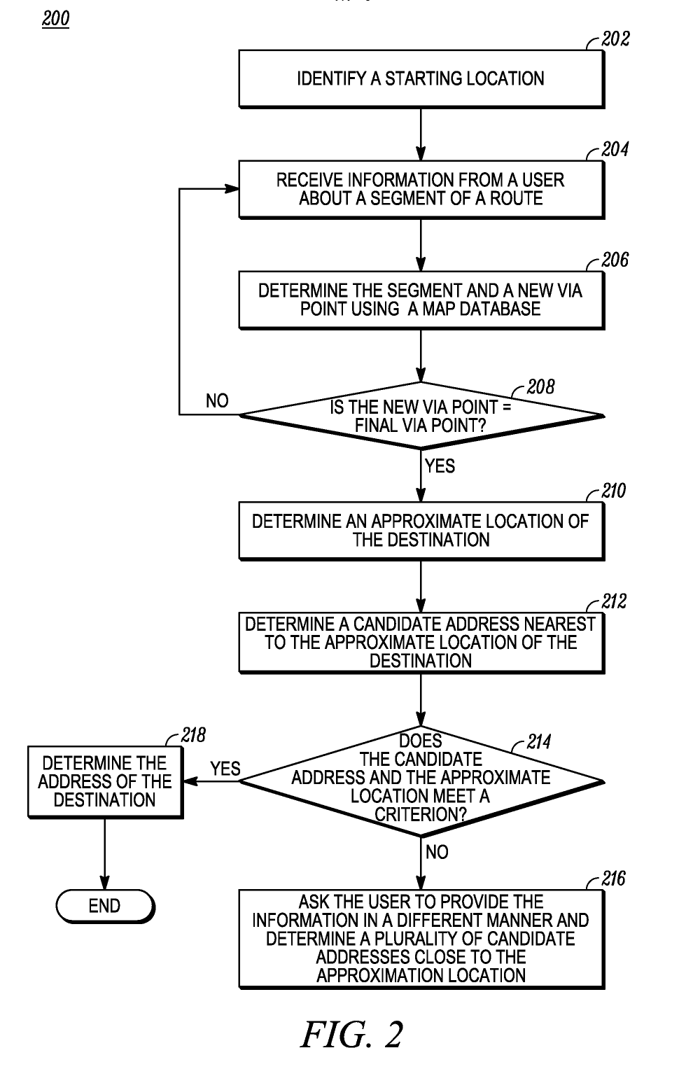

Referring to FIG. 2, a flowchart of some steps of a method in accordance with some embodiments is shown. At step 202, the electronic device 300 identifies a starting location 102. The electronic device 300 receives information about the starting location 102 either from the user or from the GPS device. The GPS device may provide information to the electronic device 300 and the information may comprise co-ordinates of the starting location 102. In addition, the user may read the GPS co-ordinates and type the GPS co-ordinates into the electronic device 300 to identify the starting location 102. Moreover, the user may also select a point on a map (that is presented to the user by the electronic device 300), to identify the starting location 102. Moreover, the user could also press a button that captures GPS data from an internal or external GPS device to identify the starting location 102, if the user and/or the GPS device are at the starting location 102.

At step 204, the electronic device 300 receives information from the user about the segment of the route 100. In some of the embodiments in which the user travels on the route 100, the information may be received from the GPS device. Receiving information about the segment of the route 100 from the user further comprises receiving at least one of the (a) identification of a path, (b) one or more distances along the path, (c) one or more intersections along the path, (d) one or more structures along the path, (e) one or more stroke inputs from the touch sensitive device and (f) one or more inputs from the GPS device.

In addition, a map may be presented and the interpretation of the electronic device 300 of the route 100 may be shown and corrected until the route 100 to the destination 134 is generated. If the map is not presented to the user, the user explains the route 100 to the electronic device 300 as described above. The map may be stored either internal to the electronic device 300 or in an external memory 304/server 310 (as shown in FIG. 3).

At step 206, the electronic device 300 determines the segment and a new via point using a map database. The map database may be stored either internal to the electronic device 300 or in an external memory 304/sever 310. At step 208, the electronic device 300 determines whether the new via point is the final via point (that is, the final via point before the destination 134). This may be done by an input from the user identifying a via point as the final via point, or may be done by determining that an input from the user is an approximate location 132 of the destination 134, from which it may be deduced that the previous via point was the final via point. When the new via point is not the final via point, the electronic device 300 receives information from the user again about the further segments of the route 100. The steps of receiving the information and determining the segments continue until the new via point is the final via point. When the new via point is the final via point, the electronic device 300 may then determine a final segment 129. The final segment 129 may be defined as the route 100 from the final via point to the approximate location 132. The final segment 129 may also be used to determine the approximate location 132 or/and the address of the destination 134. As an alternative to using a distance or an easily identifiable structure to define the approximate location 132 or the address of the destination 134, a plurality of structures may be used. For example, another way to determine the approximate location 132 or the address of the destination 134 may be to count structures, for example, 5^{th} house on the right, along the final segment.

Vectors may be defined, used or even drawn between via points, but in many embodiments, the electronic device 300 may establish geographic locations of succeeding via points of connected segments in the route 100. The segments may follow the paths, roads, rail track, bike trails, walkways, etc and the segments may not necessarily be straight. Vectors may be generated by differences in GPS locations or by commands such as left, right, distance, etc.

At step 210, the electronic device 300 determines the approximate location 132. At step 212, the electronic device 300 determines the candidate address 130 nearest to the approximate location 132 of the destination 134 using an address database. The address database may be stored either internal to the electronic device 300 or in an external memory 304/server 310. At step 214, it may be determined whether the candidate address 130 and the approximate location 132 meet a criterion. In some embodiments, the candidate address 130 and the approximate location 132 are said to meet the criterion when the distance between the candidate address 130 and the approximate location 132 is less than a predetermined distance, such as 100 yards or any such distance. When the candidate address 130 and the approximate location 132 do not meet the criterion, the electronic device 300 may ask the user to provide the information again, in some instances in a different manner. Alternatively, the electronic device 300 may determine a plurality of candidate addresses close to the approximate location 132 when the criterion is not met. The electronic device 300 may calculate the distance and direction of each of the plurality of candidate addresses from the approximate location 132 and present the distance and direction of each to the user, so that the user may choose the appropriate one of them and select the candidate address 130. When the candidate address 130 and the approximate location 132 meet the criterion, the electronic device 300 determines the address of the destination 134.

Referring to FIG. 3, a block diagram of an electronic device 300 is shown in accordance with some embodiments. The electronic device 300 comprises at least one memory 304, at least one output modality 302, at least a processor 306 and at least one input device 308. The figure also shows a server 310 which is used by the electronic device 300 in accordance with some embodiments.

The at least one memory 304 may be used to store a map database and/or an address database. The processor 306 may access the map database and the address database from the at least one memory 304. The server 310 may also be used by the processor 306 to access the map database and the address database.

At least one input device 308 is used by a user to provide information to the electronic device 300. The one input device 308 may be, for example, a keyboard, a microphone and speaker, a touch sensitive device, a GPS device, etc. At least one output modality 302 could be, for example, a display or a text to speech modality for the user. The output modality 308 may be used to display information related to the destination 134 or/and approximate location 132 or/and candidate address 130. For example, the information could be the address of the destination 134/approximate location 132 or it could be the name of the resident at the destination 134/approximate location 132 or it could be the name of the building/business, etc. The information may be determined by the electronic device 300.

The processor 306 is controlled by programmed instructions stored in the at least one memory 304. The processor 306 perform the functions of (a) receiving information from the user about a segment of a route 100, using the at least one input device 308, (b) determining the segment and a new via point using the map database stored in the at least one memory 304, (c) determine whether the new via point is a final via point, (d) determining the address of the destination 134 after the new via point has been determined to be the final via point, and (e) presenting the address of the destination 134 on the at least one output modality 302. The processor 306 may also determine a candidate address 130 and may also present information related to the candidate address 130 at the least one output modality 302.

It will be appreciated that embodiments of the invention described herein may be comprised of one or more conventional processor 306 and unique stored program instructions that control the one or more processors 306 to implement, in conjunction with certain non-processor circuits, some, most, or all of the functions of descriptive route generation methods described herein. The non-processor circuits may include, but are not limited to, a radio receiver, a radio transmitter, signal drivers, clock circuits, power source circuits, and user input devices. As such, these functions may be interpreted as steps of a method to perform descriptive route generation methods. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for determining an address of a destination comprising:
receiving information from a user about a segment of a route;
determining the segment and a new via point using a map database;
determine whether the new via point is a final via point; and
determining the address of the destination after the new via point has been determined to be the final via point.

2. The method of claim 1, further comprising repeating the receiving of the information and the determining of the segment when the new via point is not the final via point.

3. The method of claim 1, wherein receiving information from the user further comprises receiving at least one of the following:
identification of a path;
one or more distances along the path;
one or more intersections along the path;
one or more structures along the path;
one or more stroke inputs from a touch sensitive device; and
one or more inputs from a Global Positioning System (GPS) device.

4. The method of claim 1, wherein determining the address of the destination further comprising:
receiving information about an approximate location of the destination;
determining a candidate address nearest to the approximate location of the destination using an address database; and
presenting the address of the destination at an output modality when the distance between the candidate address and the approximate location meets a criterion.

5. The method of claim 4, wherein receiving information about the approximate location further comprises receiving at least one of the following:
identification of a path;
one or more distances along the path;
one or more intersections along the path;
one or more structures along the path;
one or more stroke inputs from a touch sensitive device; and
one or more inputs from the GPS device.

6. The method of claim 4, further comprising asking the user to provide the information in a different manner, when the criterion is not met.

7. The method of claim 4, further comprising determining a plurality of candidate addresses close to the approximate location, from which the user may select one, when the criterion is not met.

8. The method of claim 4, further comprising determining information related to the candidate address close to the approximate location and presenting the information related to the candidate address at the output modality.

9. The method of claim 4, wherein receiving information from the GPS device further comprising determining segments based on differences in GPS locations.

10. The method of claim 1, further comprising identifying a starting location prior to determining a first segment.

11. The method of claim 1, wherein the route comprises a plurality of connected segments.

12. The method of claim 1, further comprising determining a final segment of the route, wherein the final segment determines the address of the destination.

13. The method of claim 1, further comprising stroke generation of one or more segments.

14. The method of claim 1, further comprising determining a specific via list.

15. An electronic device comprising:
at least one memory;
at least one output modality;
at least one input device;
at least a processor, controlled by stored programmed instructions in the at least one memory to perform the functions of
receiving information from a user about a segment of a route, using the at least one input device;
determining the segment and a new via point using a map database stored in the at least one memory;
determine whether the new via point is a final via point;
determining an address of the destination after the new via point has been determined to be the final via point; and
presenting the address of the destination on at least one output modality.

16. The electronic device of claim 15, further comprises repeating the receiving of the information and the determining of the segment when the new via point is not the final via point.

17. The electronic device of claim 15, wherein receiving information from the user further comprises receiving at least one of the following:
identification of a path;
one or more distances along the path;
one or more intersections along the path;
one or more structures along the path;
one or more stroke inputs from a touch sensitive device; and
one or more inputs from a Global Positioning System (GPS) device.

18. The electronic device of claim 15, wherein the processor determines the address of the destination by:
receiving information about an approximate location of the destination;
determining a candidate address nearest to the approximate location of the destination using an address database stored in the at least one memory; and
presenting the address of the destination at the output modality when the distance between the candidate address and the approximate location meets a criterion.

19. The electronic device of claim 18, wherein the processor receives information about the approximate location by receiving at least one of the following:
identification of a path;
one or more distances along the path;
one or more intersections along the path;
one or more structures along the path;
one or more stroke inputs from a touch sensitive device; and
one or more inputs from the GPS device.

20. The electronic device of claim 18, further comprises asking the user to provide the information in a different manner, when the criterion is not met.

21. The electronic device of claim 18, further comprising determining a plurality of candidate addresses close to the approximate location, from which the user may select one, when the criterion is not met.

22. The electronic device of claim 18, further comprising determining information related to the candidate address close to the approximate location and presenting the information related to the candidate address at the output modality.

23. The electronic device of claim 18, wherein receiving information from the GPS device further comprising determining segments based on differences in GPS locations.

24. The electronic device of claim 15, further comprising identifying a starting location prior to determining a first segment.

25. The electronic device of claim 15, wherein the route comprises a plurality of connected segments.

26. The electronic device of claim 15, further comprising determining a final segment of the route, wherein the final segment determines the address of the destination.

27. The electronic device of claim 15, further comprising stroke generation of one or more segments.

28. The electronic device of claim 15, further comprising determining a specific via list.
